(19) United States
(12) Patent Application Publication
(10) Pub. No.: US 2014/0226002 A1
(43) Pub. Date: Aug. 14, 2014

(54) MEASURING DEVICE THAT CAN BE OPERATED WITHOUT CONTACT AND CONTROL METHOD FOR SUCH A MEASURING DEVICE

(71) Applicants: Bernhard Metzler, Dornbirn (AT); Stefan Sieber, Widnau (CH); Werner Lienhart, Graz (AT); Hans-Martin Zogg, Uttwil (CH)

(72) Inventors: Bernhard Metzler, Dornbirn (AT); Stefan Sieber, Widnau (CH); Werner Lienhart, Graz (AT); Hans-Martin Zogg, Uttwil (CH)

(73) Assignee: LEICA GEOSYSTEMS AG, Heerbrugg (CH)

(21) Appl. No.: 14/235,021

(22) PCT Filed: Jul. 20, 2012
(86) PCT No.: PCT/EP2012/064307

§ 371 Date: Apr. 17, 2014

(30) Foreign Application Priority Data
Jul. 25, 2011 (EP) 11175257.2

(51) Int. Cl. G01C 11/02; H04N 5/232

(52) U.S. Cl. CPC G01C 11/02; H04N 5/23219
USPC 348/78

(57) ABSTRACT

A geodetic measuring instrument for determining the position of a target point includes a sighting apparatus that can be pivoted with respect to a base of the measuring instrument to change the orientation of the sighting apparatus. The geodetic measuring instrument has at least one objective unit defining an optical target axis and has angle measurement functionality for precisely detecting the orientation of the target axis. Evaluating means store to and control the orientation of the sighting apparatus. An eye image recording unit records eye images of an eye of a user. The evaluating means perform automatic sighting functionality regardless of viewing direction in such a way that the following occurs automatically after the function has started: at least one eye image is recorded, a viewing direction of the user eye is determined, or eye information suitable for deriving a viewing direction of the user eye is determined.

The invention relates to a measuring device that can be controlled without contact, and to a method for controlling such a measuring device.

For measuring a target point, numerous geodetic measuring appliances have been known since ancient times. In this case, distance and direction or angle from a measuring appliance to the target point to be measured are recorded and, in particular, the absolute position of the measuring appliance together with reference points possibly present are acquired as spatial standard data.

Generally known examples of such geodetic measuring appliances include theodolite, tachymeter and total station, which is also designated as electronic tachymeter or computer tachymeter. One geodetic measuring device from the prior art is described in the publication document EP 1 686 350, for example. Such appliances have electrical-sensor-based angle and distance measuring functions that permit direction and distance to be determined with respect to a selected target. In this case, the angle and distance variables are determined in the internal reference system of the appliance and, if appropriate, also have to be combined with an external reference system for absolute position determination.

Modern total stations have microprocessors for digital further processing and storage of acquired measurement data. The appliances generally have a compact and integrated design, wherein coaxial distance measuring elements and also computing, control and storage units are usually present in an appliance. Depending on the extension stage of the total station, motorization of the targeting or sighting device and means for automatic target seeking and tracking can additionally be integrated. As a human-machine interface, the total station can have an electronic display control unit—generally a microprocessor computing unit with electronic data storage means—with display and input means, e.g. a keyboard. The measurement data acquired in an electrical-sensor-based manner are fed to the display control unit, such that the position of the target point can be attained, optically displayed and stored by the display control unit. Total stations known from the prior art can furthermore have a radio data interface for setting up a radio link to external peripheral components such as e.g. a handheld data acquisition device, which can be designed, in particular, as a data logger or field computer.

For sighting or targeting the target point to be measured, geodetic measuring appliances of the generic type have a telescopic sight, such as e.g. an optical telescope, as sighting device. The telescopic sight is generally rotatable about a vertical axis and about a horizontal tilting axis relative to a base of the measuring appliance, such that the telescopic sight can be aligned with the point to be measured by pivoting and tilting. Modern appliances can have, in addition to the optical viewing channel, a camera for acquiring an image, said camera being integrated into the telescopic sight and being aligned for example coaxially or in a parallel fashion, wherein the acquired image can be represented, in particular, as a live image on the display of the display control unit and/or on a display of the peripheral device—such as e.g. the data logger—used for remote control. In this case, the optical system of the sighting device can have a manual focus—for example an adjusting screw for altering the position of a focusing optical system—or an autofocus, wherein the focus position is altered e.g. by servomotors. Automatic focusing devices for telescopic sights of geodetic devices are known e.g. from DE 19710722; DE 19926706 and DE 19949580.

The optical system or the optical viewing channel of the sighting device usually contains an objective lens group, an image reversal system, a focusing optical system, a reticle for producing a crosshair, and an eyepiece, which are arranged e.g. in this order from the object side. The position of the focusing lens group is set depending on the object distance in such a way that a sharp object image arises on the reticle arranged in the focusing plane. The said image can then be viewed through the eyepiece or e.g. acquired with the aid of a camera arranged coaxially.

By way of example, the construction of generic telescopic sights of geodetic appliances is disclosed in the publication documents EP 1 081 459 or EP 1 662 278.

In known measuring devices it is customary to align them coarsely with a target. Afterward, the target is acquired by the user via an optical system such as a telescope, for example, and the measuring device is aligned precisely with the target by means of fine setting. This is followed by customary measuring tasks such as determining the distance, the direction, position, etc. Articles introduced into the terrain such as, for example, prisms, rods or mirrors and also stationary objects such as, for example, mounting summits, church towers, pylons and so on can be used as target.

In the known measuring methods it is repeatedly necessary for the user to look away from the target being viewed through the optical system, in order to meet diverse settings on the measuring appliance. This is normally done by means of setting means, such as switches, buttons or levers, which are fitted on the appliance itself or a remote control and are to be operated manually. In order to operate these means, the user's eye must regularly be concentrated on different distances and articles, for which reason it is susceptible to fatigue. Moreover, regularly touching the measuring device in order to actuate the latter (for example in the course of fine setting to a measurement target) can repeatedly result in vibrations and impacts, as a result of which the accuracy of the measurement can be impaired or the measurement work is at least protracted. As a result, particularly in the case of high-precision measurements, delays can repeatedly occur during the measurement.

Therefore, there is a need for a measuring device which can be actuated in a manner free of contact, and for a method by which such a measuring device can be controlled.

According to the invention, a measuring device comprises a targeting device and optionally a representation device for representing an image of the target sighted by the targeting device. Furthermore, an eye image acquisition device oriented toward a user end of the targeting device is provided, which is designed to continuously acquire images of a user's eye (eye images), said eye being situated in particular at the user end. The eye image acquisition device can acquire the eye images as part of a recording of the whole face or of parts of the face of the user, in particular comprising the visible part of the eye with the rim of the eye, or else acquire only part of the user's eye, in particular the front part of the eyeball containing the cornea with iris and pupil. Eye image acquisition devices within the meaning of this invention can in this case be cameras or else light-sensitive sensors, for example two-dimensional CCD sensors or, as described in U.S. Pat. No. 7,697,032 CMOS image sensors.

On account of the horizontally elliptically shaped and spherically curved cornea of the human eye, an eye image within the meaning of this invention can alternatively also be acquired by three-dimensionally scanning the surface of the user's eye, in particular the visible part of the eyeball, for example by means of a scanner. A three-dimensional image of the eye can also be generated by means of at least two cameras.

The eye image acquisition device can be constituted in such a way that it is able, as described for example in WO 99/05988, to actively illuminate the user's eye. As a result, eye images can still be acquired even in darkness or when the eye is shaded as can be brought about for example by great proximity of the eye to the eyepiece. LEDs, in particular, are appropriate as illumination means. In order to prevent the user's eye from being dazzled, which would make target identification by the user considerably more difficult when there is low brightness, this active irradiation of the user's eye preferably takes place in a non-visible wavelength range of electromagnetic radiation, for example by means of infrared light, as described in WO 2011/064534. For this purpose, the eye image acquisition device must be suitable for receiving the electromagnetic radiation respectively emitted.

On the part of the measuring appliance, evaluation means for data storage and control of the alignment of the targeting unit are provided, which are designed for implementing an automatic viewing-direction-dependent targeting functionality. The evaluation means contain, in particular, machine-readable data carriers with computer program code for carrying out the method according to the invention. For determining the viewing direction of the user's eye, the evaluation means function as a viewing direction determining device.

The viewing direction determining device serves to determine, in each of the continuously acquired eye images, the pupil midpoint of the user's eye, or to acquire information from which the pupil midpoint can be derived (eye information); this can be, for example, the position of the pupil or iris, or generally also the distribution of bright and dark areas in the acquired eye image. The determination of the pupil midpoint or of other eye features on the basis of the eye images can preferably take place by means of image recognition systems—well known to the person skilled in the art—with a pattern recognition of a mask for the form of the eye and another for the pupil or other eye features. On the basis of the determined or derived position of the pupil midpoint, the viewing direction determining device then determines the viewing direction of the user's eye.

Furthermore, the viewing direction determining device can be able to determine the distance between the—determined or derived—pupil midpoint and the optical axis of the targeting device. On the basis of the determined distance, the viewing direction determining device can then determine the viewing direction of the user's eye.

Known measuring devices, such as total stations, for example, can have targeting devices having telescopes, wide angle cameras, panoramic cameras, axial cameras and so on. A representation device serves for representing the image of a target sighted by the targeting device, said representation device being embodied for example as a display in the targeting device. Since the targeting device is able to show a real image of the sighted target in its image plane, e.g. an eyepiece of the targeting device can serve as the representation device, said eyepiece enabling the image to be observed directly by the human eye.

Alternatively or additionally, a ground-glass screen in the image plane can serve as the representation device, which can be embodied e.g. as a photographic sensor. The image signal can then be transmitted to a display, such as e.g. an LCD monitor, provided within or outside the targeting device.

By way of example, a video camera can serve as the eye image acquisition device for acquiring continuous eye images of a user's eye situated at the user end, said video camera preferably being aligned along the optical axis of the targeting device. However, the eye image acquisition device can also be provided outside the targeting device. It can be fitted for example in a handheld operating unit or else in special spectacles.

In the acquired eye image, by means of image extraction methods it is possible to determine the exact position of the pupil or of the pupil midpoint of the user's eye. Since the position of the optical axis of the targeting device in relation to the acquired eye images of the pupil midpoint is known, it is possible to determine a distance—preferably a pixel distance—between the pupil midpoint and the optical axis. On the basis of the determined distance, it is then possible to determine the viewing direction of the user's eye. Incidentally, this does not necessitate representing the eye image in a manner visible to the user.

Depending on the targeting device used, according to the beam path in the targeting device it may be sufficient to determine the distance between the pupil midpoint and the optical axis since the viewing direction of the user's eye is defined as a straight line through the pupil midpoint.

In order to increase the accuracy, it is possible to take account of the anatomy of the human eye. Since the human eyeball is substantially spherical, and its diameter is 2.5 cm on average, an angle between the viewing direction of the user's eye and the optical axis can be determined in a simple manner as an angular offset. This is possible by means of a sine law or rule of three, for example. In this case, the midpoint of the eyeball essentially serves as the pivot point thereof about which the change in the viewing direction takes place.

As an alternative thereto for checking the viewing direction determined, a calibration device can be provided, which successively marks individual pixels in the displayed image of the target, e.g. by means of illuminating said pixels, and determines the distance between the pupil midpoint and the optical axis upon consideration of the pixels respectively marked. Since the respective viewing direction corresponding to the marked points is known, it is possible in this way to ascertain a deviation in the result of the determination of the viewing direction. According to the deviations ascertained, the viewing direction determined can then be corrected during operation. The viewing direction can then be adapted for example by interpolation of the deviations measured previously.

It is possible, after determining the viewing direction of the user's eye, to vary the position of the targeting device on the basis of the determined distance and/or angular offset in such a way that the optical axis of the targeting device and the viewing direction of the user's eye coincide. This corresponds, for example, to the fine setting to a measurement target sighted by the user through a telescope. In this case, the change in the position of the targeting device can be effected around the midpoint of the user, in order that the user is not distracted by a variation of the representation of the sighted target that takes place as a result of the movement of the targeting device.

A reticle can advantageously be provided in the targeting device. The reticle can be fixedly assigned to the optical axis of the targeting device, or it can be embodied as a movable reticle. However, a fixed and one or more movable reticles can also be provided. According to the determined viewing direction of the user's eye, the position of the respective reticle can then be varied in such a way that the viewing direction of the user's eye is directed through the reticle.

It is advantageously possible to make the variation speed in the case of the alignment change or the movement of the reticle dependent on the determined distance and/or angular offset. In this regard, it is possible, in the case of relatively large distances/angular offsets, to carry out the change in the position of the targeting device and/or of the reticle(s) with a higher speed than that in the case of a small distance/angular offset.

It is advantageously possible to output a control signal, for example as a result of blinking of the user's eye. For this purpose, the view determining device is designed, for example, in such a way that it interprets as control signal a specific number of eye images in which a pupil midpoint cannot be determined. A closed eye or the process of closing and opening the eye can also be recognized as blinking and interpreted as control signal, in particular by means of image recognition systems with a pattern recognition of a mask.

Movements of the eyeball of the user's eye (eye movements) or combinations of eye movements can also be interpreted as control signal. By means of a calibration device, for example before the beginning of the measurement work, various time durations and/or repetitions of blinking with the user's eye or specific eye movement combinations can be allocated to different control commands. By way of example, the beginning and/or the end of a dynamic change in the alignment of the targeting device can be initiated by means of such a control command without contact.

Alternatively or additionally, the representation of the target can be superimposed or replaced by optically represented control commands. By way of example, the control commands can be visible to the user in the form of pictograms or else in the form of text. In this case, the viewing direction determination can be designed such that the determined distance between the pupil midpoint and the optical axis (for example corresponding to the midpoint axis of the representation) is taken as a basis for identifying which of the optically represented control commands is sighted by the user, i.e. which control command lies in the viewing direction. This relevant control command can then be activated by means of blinking, for example. In this case, it can advantageously be possible to identify the currently sighted control command by color variation and/or illumination.

It can likewise be possible to provide a measuring device according to the invention with a target point identification device. The target point identification device is able to identify possible target points in the representation of the sighted target which lie in the viewing direction of the user's eye, and to mark them for example by illumination or by a color change. In response to the outputting of a control signal, for example as a result of blinking once, it is possible for the target points to be targeted, measured and stored together with their data such as distance, direction, height, etc. in a storage device. With the use of a plurality of reticles, correspondingly a plurality of target points can be marked in succession.

In a method according to the invention for controlling a measuring device which represents a target sighted by a sighting device, an image of a user's eye (eye image) is acquired, in particular continuously. A viewing direction of the user's eye can be derived on the basis of specific features of the eye image. This can be, for example, a distance between a pupil midpoint of the user's eye and the optical axis of the targeting device, or a position of the pupil or of the iris in relation to the extent of the eye. The determined distance is taken as a basis for varying the position of the optical axis of the targeting device or the position of a movable reticle in the representation of the sighted target. As a result, the optical axis of the targeting device coincides with the viewing direction of the user's eye or the viewing direction of the user's eye is directed through the reticle.

On the basis of the distance between the pupil midpoint and the optical axis, on the one hand, and a diameter of the eyeball, on the other hand, it is possible to determine an angle between the viewing direction of the user's eye and the optical axis of the angular offset. Alternatively or additionally, it is possible, by means of successively marking individual pixels and the distance between the pupil midpoint and the optical axis that is respectively determined in this case, to determine a deviation of the determined viewing direction of the user's eye from the actual viewing direction of the user's eye.

The alignment of the targeting unit can advantageously be changed with a speed that is variable depending on the distance between the pupil midpoint of the user's eye and the optical axis of the targeting device.

The representation of the target can be superimposed or replaced by optically represented control commands. With the aid of the viewing direction determining device, a sighted control command from among the optically represented control commands can be selected on the basis of the determined distance between the pupil midpoint and the optical axis of the targeting device.

Advantageously, a target point identification device can identify possible target points lying near the viewing direction in the representation of the sighted target and can mark them. In response to the outputting of a control signal, the corresponding target point can be targeted by the targeting device, measured and stored together with its associated data such as direction, distance, height, etc.

The European application EP11150580.6 describes a concept for a dynamic targeting function which comprises a control by touching a touch-sensitive surface, wherein said surface is divided into sectors formed by a virtual line grid. This function, too, can be controlled by the eye without contact in accordance with the present invention.

The measuring device according to the invention and the method according to the invention are described in greater detail purely by way of example below on the basis of concrete exemplary embodiments illustrated schematically in the drawings, and further advantages of the invention are also discussed. Schematically in the figures:

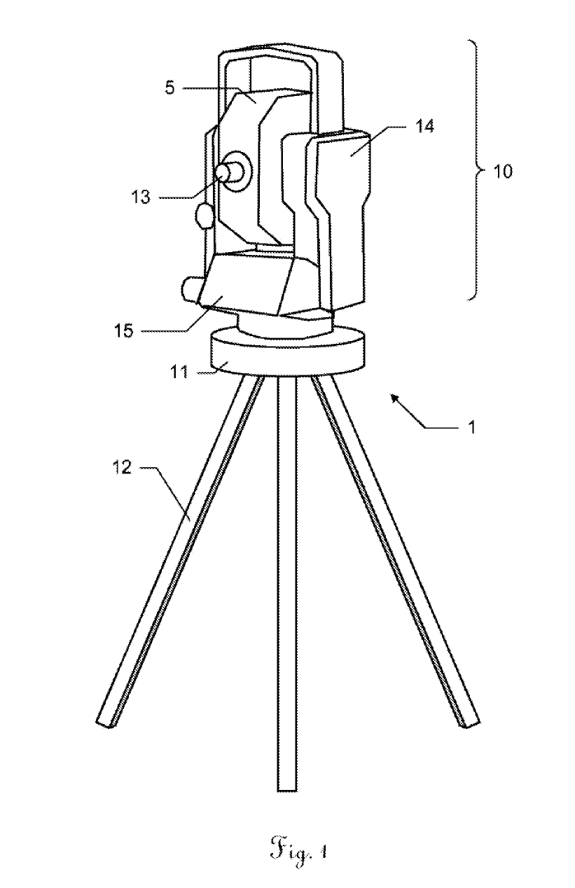

FIG. 1 shows a geodetic measuring appliance according to the invention designed as a total station;

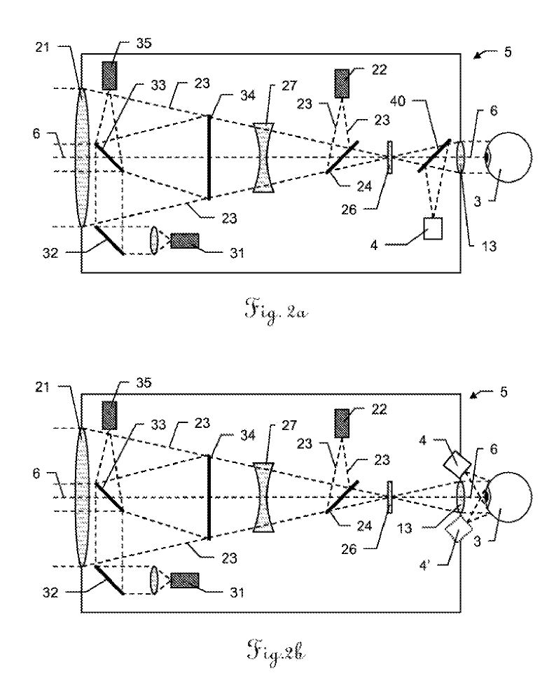

FIG. 2a shows a first embodiment of an optical construction of a targeting device of a geodetic measuring appliance according to the invention;

FIG. 2b shows a second embodiment of an optical construction of a targeting device of a geodetic measuring appliance according to the invention;

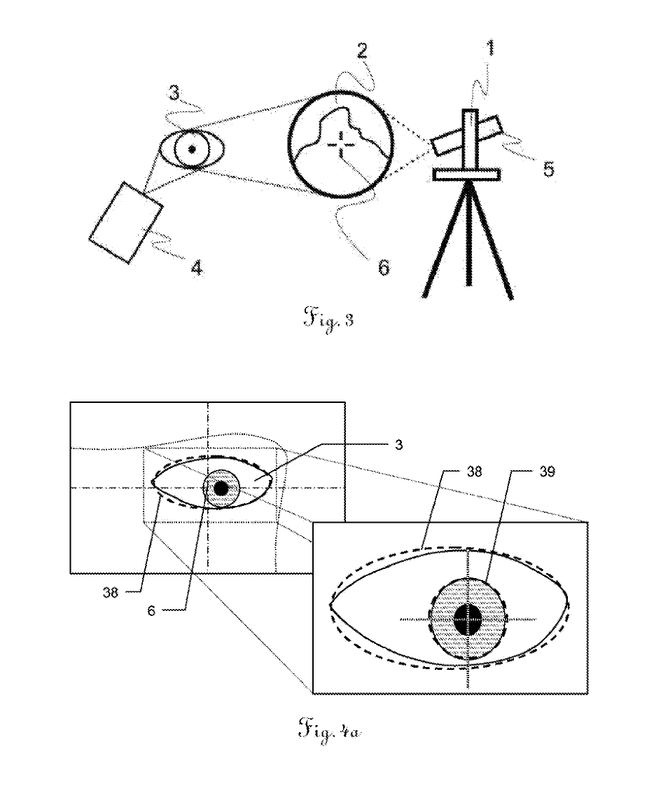

FIG. 3 shows a construction of a measuring device according to the invention;

FIG. 4a shows an eye image and a pattern recognition of the user's eye and of the pupil midpoint by means of masks;

FIG. 4b shows an eye image with a user's eye recorded off-center;

FIG. 4c shows an eye image with a closed user's eye;

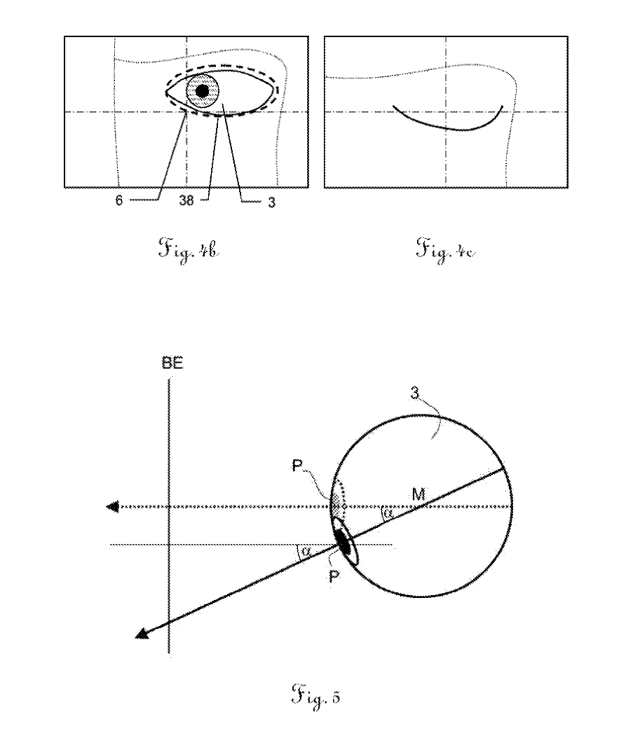

FIG. 5 shows an exemplary illustration for determining an angular offset or a viewing direction on the basis of a pupil distance from an optical axis;

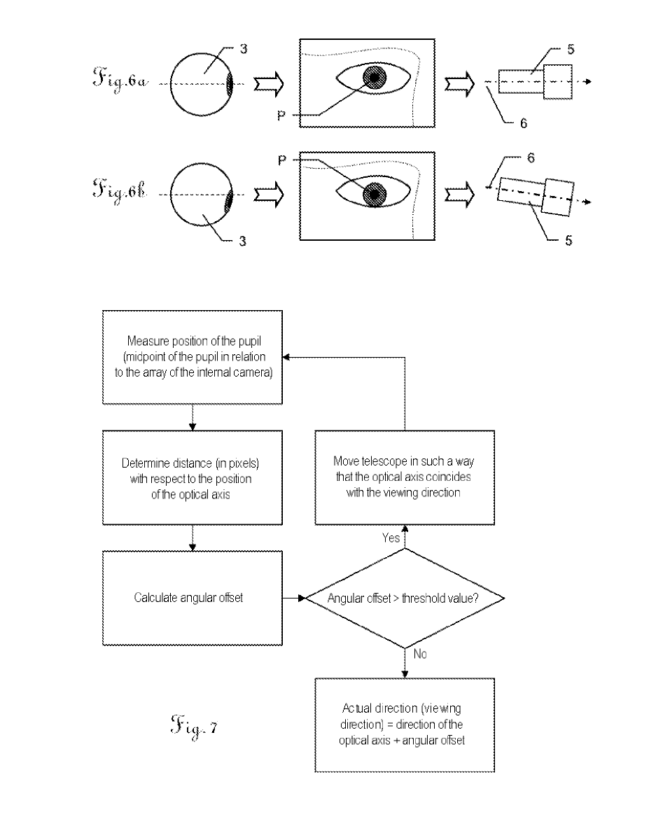

FIG. 6a shows a first example of an alignment of a targeting device on the basis of eye images of a user's eye;

FIG. 6b shows a second example of an alignment of a targeting device on the basis of eye images of a user's eye;

FIG. 7 shows a flow chart for the movement of a telescope;

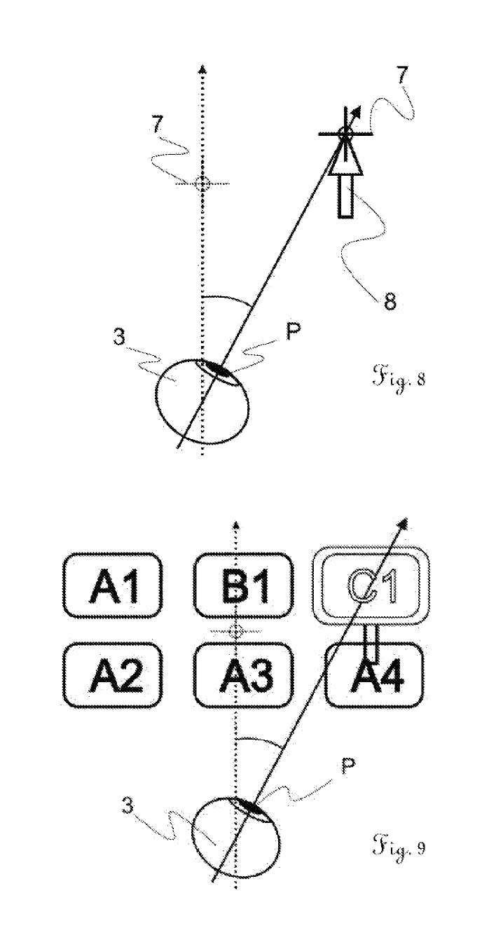

FIG. 8 shows an example of a further embodiment, in which a reticle is provided in a displaceable manner in an image of a target sighted by the targeting device;

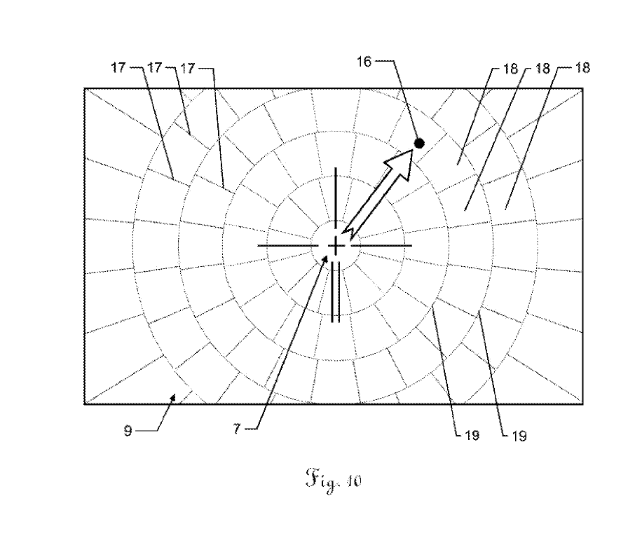

FIG. 9 shows the image from FIG. 8, into which control commands are inserted; and

FIG. 10 shows the functioning of a dynamic targeting functionality on the basis of an example.

FIG. 1 shows a geodetic measuring appliance 1 according to the invention that is designed as a total station and serves for measuring horizontal angles, vertical angles and distances with respect to a target object situated at a distance.

The total station is arranged on a stand 12, wherein a base 11 of the total station is directly and fixedly connected to the stand. The main body of the total station, which is also designated as the upper part 10, is rotatable about a vertical axis relative to the base 11. In this case, the upper part 10 has a support 14, formed e.g. by two columns, a sighting device 5, for example a telescope, which is mounted in a manner rotatable about the horizontal tilting axis between the columns, and an electronic display control unit 15. The display control unit 15 can be designed in a known manner for controlling the measuring appliance 1 and for processing, displaying and storing measurement data.

The sighting device 5 is arranged on the support 14 in a manner rotatable about a horizontal tilting axis and can thus be pivoted or tilted horizontally and vertically relative to the base 11 for alignment with a target object. Motors (not illustrated here) are present for carrying out necessary pivoting and tilting movements for the alignment of the sighting device. The sighting device 5 can be embodied as a common sighting device structural unit, wherein an objective, a focusing optical system, a coaxial camera sensor, the eyepiece 13 and a graphics processor can be integrated in a common sighting device housing. By means of the sighting device 5, the target object can be targeted and the distance between the total station and the target object can be acquired in an electrical-sensor-based manner. Furthermore, provision is made of means for the electrical-sensor-based acquisition of the angular alignment of the upper part 10 relative to the base 11 and of the sighting device 5 relative to the support 14. These measurement data acquired in an electrical-sensor-based manner are fed to the display control unit 15 and processed by the latter, such that the position of the target point relative to the total station can be determined, optically displayed and stored by the display control unit 15.

Up to this point, the measuring appliance is known from the prior art. In addition, according to the invention, a camera 4 (not illustrated here) oriented toward the user end of the targeting device 5 is provided as eye image acquisition device according to the invention, which can record images of the user's eye 3.

FIG. 2a shows an optical construction of a targeting device 5 of a geodetic measuring appliance 1 according to the invention. An optical target axis 6 is defined by means of an objective unit 21 and the associated beam path from a target or object to be sighted through the objective unit 21, which target axis is to be aligned with the target or object to be observed. The objective unit 21 can be constructed with a plurality of lenses. A camera sensor 22 having pixel-defined resolution serves for acquiring a camera image of an object or target to be sighted or a target mark.

A beam path 23 extends from the objective unit 21 to the camera sensor 22, which beam path can be folded with an optical deflection element 24, as illustrated in FIG. 2, or alternatively can be embodied in continuously rectilinear fashion. The optical deflection element 24 can be embodied, for example, as a beam splitter or partly transmissive mirror, such that one part, for example 50%, of the light guided in the beam path 23 as far as the deflection element 24 is directed onto the camera sensor 22 and another part can propagate further in the direction of the target axis to an eyepiece unit 13 for an observer. In the direction of propagation of the light acquired by the objective unit 21, an adjustment or alignment aid 26, for example a reticle, can be arranged fixedly upstream of the eyepiece. In addition, a focusing element 27 that is variable in terms of its positioning along the axis 6 and serves for varying the focusing position for the light acquired by the objective unit 21 can be arranged in the beam path between the objective unit 21 and the optical deflection element 24. The focusing element 27 can be embodied with a plurality of lenses. Advantageously, for the focusing element 27 provision is made of a stable, precisely reproducible positioning for image acquisition of objects arranged at a large distance with a de facto parallel beam path to the objective unit 21.

Optionally, the arrangement can additionally be equipped with means for an electro-optical distance measurement. For this purpose, as illustrated in FIG. 2, a measurement radiation source 31 (e.g. emitting in the near infrared spectral range not visible to the human eye) can be used, the measurement radiation of which is directed via an optical deflection element 32, for example a mirror, onto a further optical deflection element 33, for example a dichroic beam splitter which is reflective in the spectral range of the light source 31 and transmissive in the rest of the spectral range, and from there further through the objective unit 21 to a target mark to be sighted. In this optional embodiment of an optical construction of a targeting device of the geodetic measuring appliance according to the invention, part of the light having the wavelength of the light source 31 that is reflected diffusely or directionally at the target and is acquired by the objective unit 21 passes through the deflection element 33 and propagates further as far as a dichroic beam output coupler 34, which is designed to be reflective to light having the emission wavelength of the light source 31, and transmissive to light in the rest of the spectral range. The measurement light reflected back from the dichroic beam output coupler 34 is directed via the deflection element 33 to a detector 35 for an electro-optical distance measurement. By way of example, the light source 31 can be pulsed and the distance measurement can be effected in a known manner by determining pulse application times or phase differences between emitted light and reflected light.

Alternatively, the camera sensor 22 can also be arranged on the optical target axis 6 (not illustrated here). The beam path from the objective unit along the optical target axis 6 is ended with the camera sensor 22 in this arrangement. The camera sensor is then connected to evaluation means, which can output the currently acquired image 2 of the camera sensor 22, if appropriate with superimposed target mark patterns, to a display, if appropriate in such a way that an observer is given an impression as though said observer was seeing a direct “telescope imaging” of a viewed object, target or target pattern through the eyepiece 13. Such a system is already described in the publication document WO2010/092087A1.

Up to this point, the targeting device is known from the prior art. According to the invention, a camera 4 is additionally provided, which camera can record images of the user's eye 3 via a deflection element 40 and through the eyepiece 13.

FIG. 2b shows a second embodiment of an optical construction of a targeting device 5 of a geodetic measuring appliance 1 according to the invention. In contrast to the embodiment illustrated in FIG. 2a, the camera 4 is not fitted in the interior but rather on the outer side of the targeting device 5 and directly records images of the user's eye 3. For better acquisition of the whole eye 3 it is also possible to use a further camera 4′ or a multiplicity of cameras which can jointly record images of the user's eye 3. By using a plurality of cameras 4, 4′, it is possible also to acquire three-dimensional images of the user's eye 3 and to deduce a viewing direction for example on the basis of the curvature of the cornea of the user's eye 3. The camera 4 or the cameras can also be provided outside the targeting device 13, for example in a peripheral device of the measuring appliance 1, such as spectacles or a handheld operating unit.

FIG. 3 shows an exemplary schematic construction of a measuring device according to the invention. In FIG. 3, the measuring device is designed in the form of a total station 1 comprising a telescope 5. Reference sign 2 in FIG. 3 schematically represents an image of a measurement environment, which image is created by the telescope 5 and is an example of an image according to the invention of a target sighted by the targeting device. The telescope 5 of the total station 1 forms a targeting device according to the invention.

Reference sign 3 in FIG. 3 represents a human eye (user's eye) that views the image 2 through the eyepiece 13 of the telescope 5. Depending on the construction of the telescope 5, the created image 2 of the measurement environment can be a measurement environment viewed directly through the optical system of the telescope 5, or can be projected onto a display, such as an LCD screen, for example. Reference sign 4 in FIG. 3 denotes a camera that records, in particular continuously, eye images of the user's eye 3. In this case, the camera 4 serves as the eye image acquisition device according to the invention. The camera 4 is aligned with the optical axis of the telescope 5 of the total station 1 in such a way that a center of the eye image respectively acquired corresponds to the optical axis of the telescope 5 of the total station 1.

If the user looks exactly in the direction of the optical axis 6 of the telescope 5, which is represented by a small reticle in the image 2, the center of the pupil of the eye 3 lies exactly at the midpoint of the eye image currently acquired by the camera 4. This position corresponds to the position of the optical axis 6 in the image 2.

FIG. 4a illustrates one example of an eye image which is acquired by a camera and which is centered on the optical axis 6. The user's eye 3 can be recognized as such by image recognition and pattern recognition methods by means of a mask 38. Within the user's eye 3 recognized as such, the pupil midpoint and its position in relation to the extent of the eye are determined by means of a further mask 39 (a mask for recognizing the iris illustrated here). For the image or pattern recognition, the user's eye does not have to be located centrally on the optical axis 6, but rather, as illustrated in FIG. 4b, can also lie beyond the optical axis. If the eye is closed, as indicated in FIG. 4c, no user's eye 3 is recognized, or the fact that the eye is closed can be recognized by means of a further mask (not illustrated).

If the user moves his/her eye 3 in order to more accurately view an article or an object in the image 2 beyond the optical axis or to sight it using the eye 3, the eyeball of the user's eye 3 performs a rotational movement around the midpoint M of the eyeball in order to change the viewing direction of the eye 3 toward the sighted point. In this case, the viewing direction substantially corresponds to the axis of vision of the human eye 3, which is defined essentially by the pupil P, on the one hand, and the fovea centralis situated opposite the pupil P on the inner side of the eyeball. The fovea centralis is that part of the eye 3 which is responsible in particular for sharp color vision. The axis of vision therefore runs approximately from the fovea centralis via the midpoint M of the eyeball through the midpoint of the pupil P of the eye 3. The axis of vision in this case corresponds to the viewing direction.

The described movement of the eyeball results in a variation of the pupil position. This variation is acquired by an eye image acquisition device which is provided in the camera 4 and which is able to determine the distance between the pupil midpoint and the optical axis or the position of the pupil in relation to the extent of the eye in the form of eye image pixels. The rotational angle of the eye 3 can be derived from the position of the pupil midpoint in relation to the extent of the eye. Since the distance between the pupil and the eye image plane of the eye image acquired by the camera 4 is known, and the diameter of the human eyeball with a value of approximately 2.5 cm is likewise known, it is also possible to determine a value, for example an angle α, by which the current viewing direction deviates from the optical axis. This possibility is illustrated in FIG. 5.

FIG. 5 illustrates an eye 3, the current viewing direction of which is represented by a solid drawn line. The position of the pupil P and the viewing direction exactly straight ahead forward are represented respectively in a hatched manner and by means of a dashed line in FIG. 5. Since the distance between the pupil P and the midpoint M of the eyeball (approximately 12.5 mm), the distance between the pupil P and the image plane BE of the eye image and the distance between the pupil P and the exact center corresponding to the viewing direction directly straight ahead forward are known, the point of intersection S between the current viewing direction and the image plane BE of the eye image can be determined e.g. by means of the rule of three. Consequently, on the basis of the distance between the pupil midpoint and the center of the eye image acquired by the camera 4, it is possible for the deviation of the current viewing direction from the optical axis 6, for example expressed by the angle α, and thus the viewing direction of the user's eye 3 to be determined sufficiently accurately.

Since the viewing direction of the user's eye 3 in relation to the optical axis 6 of the telescope 5 of the total station 1 can be determined sufficiently accurately, it is likewise possible, by means of a drive device (not illustrated) to adjust the telescope 5 in such a way that its optical axis 6 is aligned with the target that the user views through the eyepiece 13, in the special case the optical axis 6 coinciding with the viewing direction of the user's eye 3. Since, in accordance with FIG. 3, the reticle is fixedly assigned to the position of the optical axis 6, the viewing direction of the user's eye 3 passes through the reticle after this adjustment.

In this case, it is possible for the telescope 5 to be adjusted around the midpoint M of the eyeball of the user's eye 3 in order to preclude a variation of the image 2 for the user as a result of a displacement of the telescope 5 or the like.

FIG. 6a schematically shows a user's eye 3 in an initial position with its viewing direction aligned exactly straight ahead forward, and also an eye image of this user's eye 3 and a telescope 5 in an initial position in which the optical axis 6 is aligned with the target viewed by the user through the eyepiece 13.

FIG. 6b illustrates the same user's eye 3 with an altered viewing direction. An altered position of the pupil P is registered in the acquired eye image. Depending on the registered position of the pupil, the viewing direction determining device determines the viewing direction of the user's eye 3, or, as illustrated in FIG. 4a, derives it by means of masks 38, 39 for eye and pupil or iris recognition from a position of the pupil P within the eye 3. A drive device (not illustrated) aligns the telescope 5 depending on the viewing direction determined or ascertained in this way, with the result that the optical axis 6 of the telescope 5 is directed at the target viewed by the user through the eyepiece 13. In this case, the telescope 5 can be aligned depending on a transmission ratio that is determined with the inclusion of a current magnification factor in the context of a calibration.

FIG. 7 shows a flowchart describing essential method steps for carrying out the exemplary embodiment described above.

After the position of the pupil has been measured and the distance between the midpoint of the pupil and the position of the optical axis has been determined, the angular offset is calculated by means of the rule of three, as has been described above. If the value determined here, for example the angle α, is less than a predefined threshold value, it is determined that the actual viewing direction corresponds to the direction of the optical axis and to the angular offset. No alteration of the position of the telescope is performed in this case.

If the calculated angular offset is greater than the predefined threshold value, it is determined that the telescope should be moved, in particular until the optical axis 6 of the telescope 5 is aligned with the target viewed by the user through the eyepiece 13.

FIG. 8 illustrates a second exemplary embodiment of the present invention. The measuring device of the second embodiment is provided with a reticle 7, the position of which is not fixedly linked to the optical axis, rather said reticle is movable. This can be achieved, for example, by the measurement environment not being viewed directly through the optical system of a telescope, but rather being projected as an image onto a display, such as an LCD screen, for example. If the user views this image, which, according to the invention, corresponds to the image of a target sighted by the targeting device, on the LCD screen, the position of said user's pupil P is likewise acquired continuously by the camera 4. The position of the reticle 7 is adapted to the determined viewing direction by means of a control device, without the need for changing the alignment of the targeting device itself. This can be done by the reticle 7 being inserted into the image represented on the LCD screen, or other known means.

In FIG. 8, the user's eye is directed at the apex of the church tower 8, and the position of the reticle 7, the original position of which in the center of the image is represented by dotted lines, is correspondingly shifted to the apex of the church tower 8 after the current viewing direction has been determined.

As a variant of the second embodiment, it is possible to analyze the representation of the target sighted by the targeting device by means of image extraction means and to determine objects of interest such as the church tower 8, for example, as measurement target. In this case, it suffices if the viewing direction of the user's eye 3 is directed in proximity to the church tower 8. Since the church tower 8 is identified as a possible measurement target, in accordance with the variant of the second embodiment the reticle 7 is positioned at the apex of the church tower 8. What is advantageous about this variant is that only a low accuracy is required when determining the viewing direction of the user's eye 3, as a result of which computing time, memory resources and so on can be saved.

In accordance with the variant of the second embodiment is it necessary to confirm that the target selected by the measuring device—the church tower 8 in the present case—actually serves as the measurement target. In order to determine the possible target definitively as the measurement target, it is possible, in particular by means of a movement of the eyelids (blinking), to output control commands since the camera 4 is preferably also able to identify a sequence of eye images in which the pupil P or other eye information cannot be acquired as blinking and to interpret this as a control command. In this case, it is possible entirely discretionarily to allocate different sequences of blinking to different control commands, as a result of which completely contactless operation is possible with the measuring device according to the invention.

Control commands can also be assigned to specific movements of the eyeball (eye movements). These can include, for example, combinations of movements of the pupil toward the left, toward the right, upward or downward. Preferably, diverse control commands are predefined by the user at the beginning of operation and are learned by the viewing direction determining device. By way of example, the beginning and/or the end of a dynamic change in the alignment of the targeting device can be initiated by means of such a contactless control command.

In accordance with a further preferred variant of the second embodiment, it is possible to insert pictograms or text fields corresponding to different control commands into the representation of the target sighted by the targeting device. In FIG. 9, these are designated by way of example by A1, B1, C1 and by A2 to A4. If the control commands are inserted, the camera 4 is able to identify the viewed control command depending on the viewing direction of the user's eye 3 and then to carry out said control command on the basis of an actuation such as blinking, for example. The control command C1, for example, is currently marked in the illustration in FIG. 8.

However, the variants described on the basis of the example of the second embodiment are not restricted to this second embodiment, but rather can, for example, also be applied in a telescope 5 in accordance with the first embodiment. For this purpose, an image of the reticle 7, of the pictograms of the control commands, etc. is projected into the image plane of the telescope 5.

FIG. 10 illustrates a further variant of the second embodiment of the invention with a dynamic targeting function. An image 2 generated by the telescope, or a display is subdivided into a virtual line grid 9, corresponding to digitized distances and directions from the target image point or the midpoint of the reticle 7 to groups of display points. In the embodiment in accordance with FIG. 10, the virtual line grid 9 is formed from concentric circular lines 19 around the midpoint of the reticle and radial lines 17 which proceed from the midpoint of the reticle and intersect said circular lines, such that the display is thereby divided into sectors 18—each containing a group of a plurality of display points. In this case, the sectors 18 each correspond to concrete values for an alignment change direction and alignment change speed when changing the alignment of the telescope 5. That is to say that the display points lying within a sector are in each case assigned the same concrete value for the alignment change direction and alignment change speed.

The alignment of the telescope 5 is changed in a vertical and, in particular simultaneously, horizontal direction, in the direction of the different marked image point 16—located in a sector—corresponding to a different spatial point to be sighted, either for as long as said different image point 16 is continuously sighted by the user's eye 3 or, after the sighted image point 16 has been marked, for example by blinking, until the attainment of the desired alignment or the cancellation of the marking. Upon cancellation of the marking, for example as a result of renewed blinking, the movement of the telescope 5 is terminated. However, a user can at any time mark or sight a different display point in a different sector 7 using said user's eye 3 in order to instigate a change in the alignment of the telescope 5 in accordance with the direction and speed assigned to this sector for changing the alignment.

Sectors situated further outward, which, as a result of their position, have a greater distance from the anchor display point (i.e. midpoint of the reticle), in this case correspond to higher alignment change speeds, and sectors situated further inward, which have a smaller distance from the anchor display point, in this case correspond to lower alignment change speeds. As the distance between the respective sectors and the anchor display point increases, therefore, the alignment change speed respectively assigned to the sectors also increases.

In this case, the sectors defined by the outermost circular line can also be assigned the highest movement speed (100%) and a marking of the anchor display point (that is to say of the midpoint of the reticle) can mean a movement speed of 0%.

Each sector 18 furthermore corresponds to a specific—that is to say assigned thereto—alignment change direction of the telescope 5 (azimuthal and elevational). When an image point e.g. to the right of the midpoint of the reticle is marked or sighted by the eye 3, the telescope 5 is moved toward the right for changing the alignment in a horizontal direction until the different image point mentioned above is no longer marked or sighted (for example because now another different display point is marked—and then the targeting unit is moved further or changed further with the direction and speed assigned to said display point—or no point is marked anymore—and the movement of the targeting unit is then stopped). The situation illustrated in FIG. 10 (with the point illustrated here as currently marked display point 16) corresponds, for instance, to a change in the alignment of the telescope 5 with an alignment change direction upward obliquely toward the right (that is to say a direction change component pointing upward and a direction change component pointing rightward, wherein the component pointing upward is chosen to be somewhat greater than the component pointing rightward) and also with an average movement speed. In particular, for this purpose the rotary drives can be driven in such a way that the targeting unit pivots upward relative to the base at 60% of the maximum pivoting speed that can be provided, and rotates rightward about the vertical axis at 40% of the maximum rotational speed that can be provided.

In particular, in this case the line grid 9 is established in such a way that a multiplicity of sectors 18 are defined, in particular at least approximately thirty sectors, specifically at least approximately fifty sectors.

As has been described above, the invention makes it possible to control a measuring device such as a total station, for example, by one or both eyes or the pupils of the user. Accordingly, it is no longer necessary to touch the measuring instrument, as a result of which vibrations and resultant disturbances of the measurement work can be avoided. Apart from the direct sighting of target points and the setting of the measuring instruments, it is also possible to perform control commands that are represented in the targeting device of the measuring device. Constantly changing between looking through the eyepiece in order to sight a target, looking at input means to be operated manually in order to give control commands, and once again looking through the eyepiece is accordingly obviated as well.

Said control commands can be inserted into an image of the measurement environment, said image being projected or represented on a display such as e.g. an LCD screen, but can also be inserted into a telescope or the like by means of a dedicated display. The selection of different menu points can be carried out for example by opening and closing (blinking) of the eye. It is likewise possible to achieve said control commands by means of a remote control, such as a radio remote control, for example.

Preferably, it can likewise be possible to temporarily switch off specific functions or the entire contactless control, in order to avoid excessive fatigue of the user and resultant erroneous operation as a result of inadvertent eye movements. By way of example, it is possible, alternatively or additionally, to activate or bring about a control by means of the user's voice. Preferably, the user's voice can serve to activate and deactivate the control by the user's eye. Alternatively, or additionally, it is also possible to use a radio remote control and/or switches or buttons on the measuring device.

In order to increase the accuracy, the measuring device can have a calibration mode in which the user is encouraged to focus a series of successively identified image points. The measurement of the pupil position that takes place simultaneously in this case makes it possible to ascertain deviations of the determined viewing direction from the actual viewing direction and thus to compensate for anatomical characteristics of the user's eye.

Control signals, such as the blinking of the user's eye, for example, can likewise be adapted by means of a corresponding calibration.

By means of the movement of the reticle as described on the basis of the second embodiment, the user can be prevented from being distracted on account of the fact that the user's eye is very close to the telescope.

Different control commands can be given by blinking of the user's eye. By way of example, closing and opening the eye once can result in the menu being inserted, opening and closing the eye twice can result in selection of the menu point currently sighted or the initiation of the measurement, and closing and opening the eye three times can bring about a termination function.

A pointer (mouse pointer) can also be inserted into the representation of the sighted target, said pointer following the pupil movement.

However, a target point can also be selected by being viewed for a relatively long period of time, such as two seconds, for example. The control is then able to display the selected target point by illumination or a color change. The displayed selection can then be confirmed by the user, for example by blinking.

Preferably, it can also be possible to control the measuring device dynamically. This means that in the case of a relatively large deviation of the pupil from the optical axis, the final speed during the change in position of the targeting device or the movement speed of the reticle is higher than that in the case of a small distance.

It goes without saying that these illustrated figures merely illustrate possible exemplary embodiments schematically. The various approaches can likewise be combined with one another and also with methods and appliances from the prior art.

1-15. (canceled)

16. A geodetic measuring appliance, for determining the position of a target point, comprising
a targeting device that is pivotable in a motorized manner relative to a base of the measuring appliance for the purpose of changing the alignment of said targeting device and has at least one objective unit that defines an optical target axis;
angle measuring functionality for high-precision acquisition of the alignment of the target axis;
an eye image acquisition device configured to acquire eye images of an eye of a user; and
evaluation means for data storage and control of the alignment of the targeting device, the evaluation means being configured to implement an automatic viewing-direction-dependent targeting functionality in such a way that the following take place automatically after the function has started:
at least one eye image is recorded;
a viewing direction of the user's eye or of eye information suitable for deriving a viewing direction of the user's eye is determined by means of image processing on the basis of the at least one eye image; and
the alignment of the targeting device is changed in a motorized manner depending on the viewing direction of the user's eye or depending on the eye information.

17. The geodetic measuring appliance as claimed in claim 16, wherein:
the eye image acquisition device is fitted in or on the targeting device.

18. The geodetic measuring appliance as claimed in claim 17, wherein:
the eye image acquisition device is configured to acquire eye images of a user's eye situated at a user end of the targeting device.

19. The geodetic measuring appliance as claimed in claim 17, wherein:
the eye image acquisition device comprises at least one camera configured to:
acquire at least three eye images per second; or
acquire individual eye images.

20. The geodetic measuring appliance as claimed in claim 16, wherein the eye information comprises at least:
a position of the pupil, of the pupil midpoint or of the iris in the eye image;
a distribution of bright and dark areas in the eye image;
a distance between the pupil, the pupil midpoint or the iris and the target axis;
a direction from the target axis to the pupil, to the pupil midpoint or to the iris;
a diameter of the eyeball of the user's eye;
a distance between the eyeball midpoint and the target axis; or
an angle between the target axis and the viewing direction.

21. The geodetic measuring appliance as claimed in claim 16, wherein
the alignment of the targeting device is variable on the basis of the viewing direction of the user's eye or the eye information in such a way that the target axis of the targeting device and the viewing direction of the user's eye coincide.

22. The geodetic measuring appliance as claimed in claim 16, wherein:
the targeting device includes an alignment aid; and
alignment of the targeting device is variable on the basis of the viewing direction of the user's eye or the eye information in such a way that the viewing direction of the user's eye is directed through the midpoint of the alignment aid.

23. The geodetic measuring appliance as claimed in claim 22, wherein:
the alignment aid comprises a reticle.

24. The geodetic measuring appliance as claimed in claim 16, wherein:
a variation speed of the alignment of the targeting device is dependent on the viewing direction of the user's eye or on the eye information.

25. The geodetic measuring appliance as claimed in claim 16, wherein:
the targeting device has a camera sensor for acquiring a camera image of the sighted target mark; and
the measuring appliance has means for representing said camera image.

26. The geodetic measuring appliance as claimed in claim 16, wherein:
the eye image acquisition device for acquiring eye images:
is equipped with an illumination device designed to illuminate the user's eye, in particular with infrared light;
comprises light-sensitive sensors; and/or
is designed to create a surface profile of the eye, in particular by means of a scanner.

27. The geodetic measuring appliance as claimed in claim 26, wherein:
the light-sensitive sensors comprise CCD or CMOS image sensors.

28. The geodetic measuring appliance as claimed in claim 16, wherein:
the geodetic measuring appliance is a theodolite or total station.

29. The geodetic measuring appliance as claimed in claim 16, wherein:
the targeting device comprises a telescope.

30. A method for controlling a targeting device of a geodetic measuring appliance, wherein
acquiring eye images of a user's eye are acquired, wherein the following take place automatically after the acquisition of the eye images begins:
recording at least one eye image;
determining a viewing direction of the user's eye or of eye information suitable for deriving a viewing direction of the user's eye by means of image processing on the basis of the at least one eye image, and
changing the alignment of the targeting device depending on the viewing direction of the user's eye or depending on the eye information.

31. The method as claimed in claim 30, wherein the eye information comprises at least:
a position of the pupil, of the pupil midpoint or of the iris in the eye image; or
a distribution of bright and dark areas in the eye image; or
a distance between the pupil, the pupil midpoint or the iris and the target axis; or
a direction from the target axis to the pupil, to the pupil midpoint or to the iris; or
a diameter of the eyeball of the user's eye;
a distance between the eyeball midpoint and the target axis; or
an angle between the target axis and the viewing direction.

32. The method as claimed in claim 30, wherein evaluation means are provided on the measuring appliance and acquire a control signal if:
the viewing direction of the user's eye or the eye information cannot be determined in a predetermined number of eye images acquired in direct succession;
a closed user's eye is determined in a predetermined number of eye images acquired in direct succession; and/or
the eye image acquisition device determines a movement or combination of movements of the viewing direction of the user's eye, said movement being defined beforehand, or derives said movement of combination of movements on the basis of the eye information.

33. The method as claimed in claim 32, wherein:
the eye images are acquired in direct succession in response to blinking by the user.

34. The method as claimed in claim 30, wherein:
the representation of the target can be superimposed or can be replaced by representations of control commands, and evaluation means of the measuring appliance select one of the represented control commands on the basis of the viewing direction of the user's eye or the eye information.

35. The method as claimed in claim 30, wherein:
a target point identification device:
identifies and marks possible target points lying near the viewing direction in the representation of the sighted target; and/or
stores said possible targets in a storage device in response to a control signal being output.

36. The method as claimed in claim 30, wherein:
the representation of the sighted target is subdivided into virtual sectors by means of a virtual line grid placed around an anchor display point, said grid being formed by concentric circular lines around the anchor display point and radial lines which proceed from the anchor display point and intersect said circular lines, wherein:
the sectors correspond to digitized values for an alignment change direction and an alignment change speed;
the alignment of the targeting device is changed with the alignment change direction and alignment change speed assigned to the respective sector for as long as one of the display points lying within said sector is marked; and
the alignment change direction and alignment change speed are correspondingly changed as soon as a display point lying within a different sector is marked.

37. A computer program product comprising program code, stored on a non-transitory machine-readable carrier, for carrying out the method as claimed in claim 30.
